(19) United States
(12) Patent Application Publication
(10) Pub. No.: US 2009/0103897 A1
(43) Pub. Date: Apr. 23, 2009

(54) METHOD FOR SYNCHRONZING AUDIO AND VIDEO DATA IN AVI FILE

(76) Inventors: Min-Shu Chen, Taipei Hsien (TW); Chi-Chun Lin, Tainan County (TW); Ji-Shiun Li, Tainan County (TW)

Correspondence Address: NORTH AMERICA INTELLECTUAL PROPERTY CORPORATION, P.O. BOX 506, MERRIFIELD, VA, 22116, US

(21) Appl. No.: 11/875,954

(22) Filed: Oct. 22, 2007

(51) Int. Cl. H04N 5/91

(52) U.S. Cl. 386/104

(57) ABSTRACT

A method for synchronizing audio and video data in an Audio Video Interleave (AVI) file, the AVI file containing a plurality of audio and video chunks, includes: determining a frame rate error of a group of consecutive main access units (GMAU) according to a video clock and an audio clock; determining a GMAU presentation time stamp (PTS) according to the frame rate error; and updating the AVI file with the GMAU PTS, so the GMAU will be played utilizing the GMAU PTS.

### BACKGROUND

Audio Video Interleave (AVI) is a file format, based on the RIFF (Resource Interchange File Format) document format. AVI files are utilized for capture, edit, and playback of audio-video sequences, and generally contain multiple streams of different types of data. The data is organized into interleaved audio-video chunks, wherein a timestamp can be derived from the timing of the chunk, or from the byte size.

In general, an AVI system may derive time information from any of the following three sources: real time clock (RTC), video-sync (V_sync), and system time clock (STC). The video encoder utilizes the video-sync for encoding video frames, and the audio encoder utilizes the STC for encoding audio frames. Both the audio and video encoder utilize the STC to determine a presentation time stamp (PTS) value for the data.

In practice, there often exists a discrepancy between the timing of the three clocks. Please refer to FIG. 1. FIG. 1 is an illustration of an AVI system comprising a system clock (RTC), a video clock (Source V-sync), and an audio clock (Encoder STC), wherein the audio clock has an error. The diagram shows four timing points. At the first timing point the system clock and video clock are in synchronization, while the audio clock has a slight error. By the fourth timing point, the audio clock has a large accumulative error.

As can be seen from FIG. 1, after a certain period of time the audio and video data will be out of synchronization. When the error becomes large, i.e. the audio data lags or precedes the video data by one or a plurality of frames, the synchronization error will be noticeable to a user. Obviously, this situation is undesirable.

### SUMMARY

It is therefore an objective of the disclosed invention to provide methods for addressing this synchronization problem.

With this in mind, a method for synchronizing audio and video data in an Audio Video Interleave (AVI) file, the AVI file comprising a plurality of audio and video chunks, is disclosed. The method comprises: determining a frame rate error of a group of consecutive main access units (GMAU) according to a video clock and an audio clock; determining a GMAU presentation time stamp (PTS) according to the frame rate error; and updating the AVI file with the GMAU PTS, so the GMAU will be played utilizing the GMAU PTS.

A second method is also disclosed. The method comprises: determining a frame rate error according to a video clock and an audio clock; and selectively adding or dropping one or a number of video or audio frames according to the frame rate error.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating timing mismatch between clocks in an AVI system.

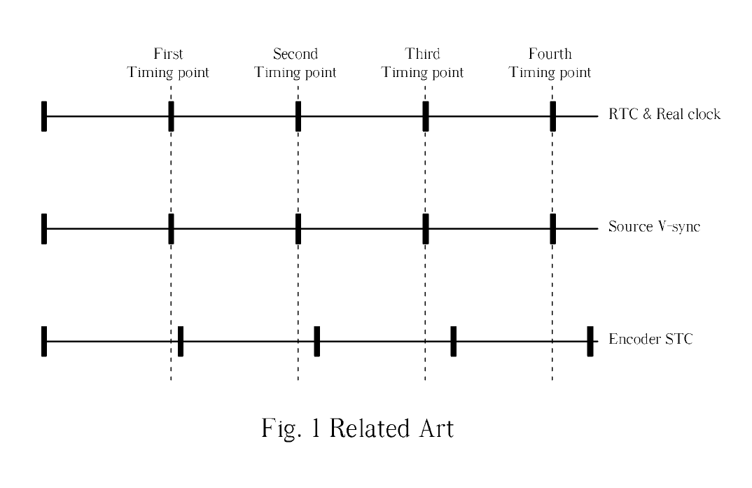

FIG. 2 is a flowchart detailing steps of a method according to a first embodiment of the present invention.

FIG. 3 is a flowchart detailing steps of a method according to a second embodiment of the present invention.

### DETAILED DESCRIPTION

A muxer of a recorder multiplexes audio and video chunks encoded by encoders to generate an AVI file. The video and audio may lose synchronization at playback since the audio and video chunks are generated based upon different respective clock sources. The present invention provides several methods to ensure audio and video synchronization during playback. In some embodiments, the muxer compares the audio and video time information to obtain a frame rate error, and then the AVI bitstream is adjusted in accordance with the frame rate error to ensure A/V synchronization. In other embodiments, time stamps are added to the AVI file and can be adjusted according to the frame rate error.

For example, if a system assumes that the video clock is accurate (e.g. v-sync), the audio data or the time corresponding to audio playback will be adjusted according to the video clock. On the other hand, if a system assumes that the audio clock (e.g. STC) is accurate, the video data or the time corresponding to video playback will be adjusted according to the audio clock. It is also possible for the system to select adjusting either audio or video data, or to select adjusting either audio or video playback time. For example, if the video or audio data are adjusted according to the frame rate error, the system may decide to adjust the one with a faster clock rate to avoid dropping data. The following description illustrates some embodiments of the methods for correcting the clock difference between audio and video data in an AVI file.

In a typical AVI system, video and audio encoders generate audio and video chunks, typically a video chunk is a video frame and an audio chunk contains one or more audio frames. The audio and video chunks are multiplexed by a multiplexer (muxer) and then sent to an authoring module. The video clock corresponding to a video chunk can be derived by the number of encoded frames and the duration of the encoded frame, where the number of encoded frames is determine by the number of v-sync patterns detected. The audio clock is derived by the STC. Ideally, the video clock and audio clock should be aligned at each data segment, so the start time of audio playback is equal to that of video playback for each data segment; however, as the audio and video data may be out of synchronization, audio may lead or lag the corresponding video. The data segment may be a frame or a group of frames.

In an embodiment, a frame rate error is derived by comparing the audio and video clock, and if the frame rate error is greater than one audio frame, for example the time for audio playback lags corresponding video playback by one frame length, such as 8 frames of audio data are multiplexed with 9 frames of video data, the muxer will purposely inform the authoring module that 9 frames of audio data have been multiplexed. Initially, the error will not be so serious as this, but over time the error will accumulate. When the frame rate error is equal to or greater than the duration of one frame, the content of the bitstream is adjusted to ensure A/V synchronization during playback. If the audio clock lags the video clock, the muxer may insert one audio frame or drop one video frame; if the audio clock leads the video clock, the muxer may insert one video frame or drop one audio frame. Frame insertion is usually accomplished by repeating a video or audio frame.

In some embodiments, the system first defines a Main Access Unit (MAU) consisting of interleaved audio and video chunks, for example, one MAU carries 0.5 seconds of data. A plurality of consecutive MAUs is known as a Group MAU (GMAU), and, for example, consists of approximately 5 minutes of data. A GMAU time stamp is defined as the audio and video presentation time stamp of a GMAU, and is inserted in a self-defined chunk of the AVI file. The GMAU time stamp can be used to calibrate audio and video clock difference. Rather than immediately correcting the synchronization error, the system accumulates the synchronization error over a complete GMAU. For example, as detailed above, if the total accumulated error corresponds to one audio frame period, the authoring module will notice that one extra frame of audio data has been muxed. Therefore, the observed number of muxed audio frames is equal to the actual number of audio frames +1. Once the number of muxed audio frames has been calculated by the system, a new GMAU PTS can be calculated and updated to the current GMAU, so when data in the GMAU is displayed, the video and audio will be displayed according to the new GMAU PTS.

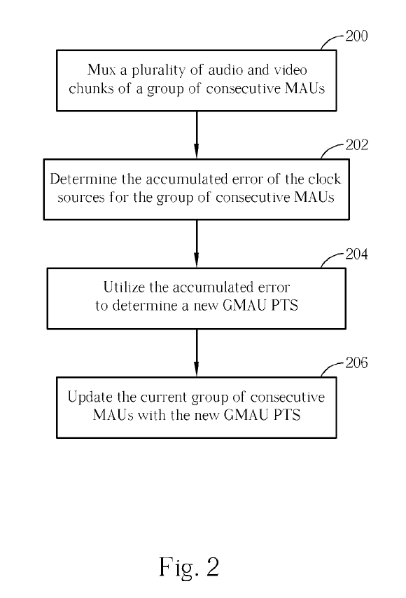

For a clearer description of this first embodiment, please refer to FIG. 2. FIG. 2 is a flowchart detailing the steps of the method. The steps are as follows:
Step 200: Mux a plurality of audio and video chunks of a group of consecutive MAUs;
Step 202: Determine the accumulated error of the clock sources for the group of consecutive MAUs;
Step 204: Utilize the accumulated error to determine a new GMAU PTS;
Step 206: Update the current group of consecutive MAUs with the new GMAU PTS.

In some other embodiments of the present invention, the video clock is still utilized as a reference, but the determination of the observed number of audio frames and the actual number of audio frames is utilized for inserting or dropping video frames in order to achieve synchronization.

As in the previous embodiment, audio and video data is muxed, and the video clock is utilized as a reference for determining the frame rate error. When this error is converted into a corresponding number of frames, the AVI system will then determine to add or drop a plurality of video frames, wherein the number of added/dropped video frames directly corresponds to the frame rate error. In other words, if it takes 9 frames time to play 8 frames of audio data, the system will add an extra video frame to the AVI file so that audio video synchronization is achieved. Similarly, if it takes 7 frames time to play 8 frames of audio data, the system will drop a video frame from the AVI file.

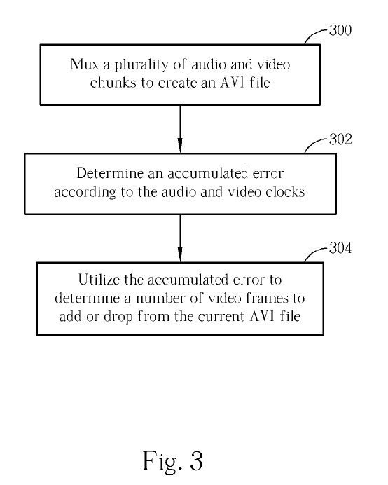

For a clearer description of this embodiment please refer to FIG. 3. FIG. 3 is a flowchart detailing steps of the method according to this embodiment. The steps are detailed as follows:
Step 300: Mux a plurality of audio and video chunks to create an AVI file;
Step 302: Determine an accumulated error according to the audio and video clocks;
Step 304: Utilize the accumulated error to determine a number of video frames to add or drop from the current AVI file.

By utilizing the video clock as a reference, only the audio data needs to be calibrated.

Those skilled in the art will readily observe that numerous modifications and alterations of the device and method may be made while retaining the teachings of the invention.

What is claimed is:

1. A method for synchronizing audio and video data in an Audio Video Interleave (AVI) file, the AVI file comprising a plurality of audio and video chunks where the AVI file is grouped into one or more Group Main Access Units (GMAUs), the method comprising:
determining a frame rate error of a GMAU according to a video clock and an audio clock;
determining a GMAU presentation time stamp (PTS) according to the frame rate error; and
updating the GMAU with the GMAU PTS, so the GMAU will be played utilizing the GMAU PTS.

2. The method of claim 1, further comprising:
multiplexing the audio and video data of the GMAU.

3. The method of claim 1, wherein the video clock is derived from video-sync of the video frames and the audio clock is derived from a system time clock (STC).

4. The method of claim 1, wherein the length of a GMAU is defined by considering a clock rate difference between the audio clock and video clock.

5. The method of claim 1, wherein the GMAU presentation time stamp is recorded in a private chunk of the AVI file.

6. A method for synchronizing audio and video data in an Audio Video Interleave (AVI) file, the AVI file comprising a plurality of audio and video chunks, the method comprising:
determining a frame rate error according to a video clock and an audio clock;
comparing the frame rate error with a frame duration; and
selectively adding or dropping at least a video frame according to the comparison result.

7. The method of claim 6, further comprising:
multiplexing the audio and video data;
wherein the step of comparing the frame rate error with a frame duration comprises:
when the frame rate error is equal to or greater than the frame duration, determining a number of video frames to be added or dropped, and when the frame rate error is less than the frame duration, accumulating the frame rate error to the subsequent GMAU.

8. The method of claim 6, wherein the step of selectively adding at least a video frame comprises repeating at least one video frame.

9. The method of claim 6, wherein the video clock is derived from video-sync of the video frames and the audio clock is derived from a system time clock (STC).

10. A method for synchronizing audio and video data in an Audio Video Interleave (AVI) file, the AVI file comprising a plurality of audio and video chunks, the method comprising:
determining a frame rate error according to a video clock and an audio clock;
comparing the frame rate error with a frame duration; and
selectively adding or dropping at least an audio frame according to the comparison result.

11. The method of claim 10, further comprising:
multiplexing the audio and video data;
wherein the step of comparing the frame rate error with a frame duration comprises:
when the frame rate error is equal to or greater than the frame duration, determining a number of audio frames to be added or dropped, and when the frame rate error is less than the frame duration, accumulating the frame rate error to the subsequent GMAU.

12. The method of claim 10, wherein the step of selectively adding at least an audio frame comprises repeating at least one audio frame.

13. The method of claim 10, wherein the video clock is derived from video-sync of the video frames and the audio clock is derived from a system time clock (STC).
